(19) United States
(12) Patent Application Publication
(10) Pub. No.: US 2016/0027097 A1
(43) Pub. Date: Jan. 28, 2016

(54) Visual Search Interface for Open Filters for Eyeglass Selection

(71) Applicant: Tibor Laczay, Novato, CA (US)

(72) Inventor: Tibor Laczay, Novato, CA (US)

(73) Assignee: ZENNI OPTICAL INC., Novato, CA (US)

(21) Appl. No.: 14/338,928

(22) Filed: Jul. 23, 2014

(51) Int. Cl. G06Q 30/06

(52) U.S. Cl. CPC G06Q 30/0643

(57) ABSTRACT

A visual search interface presents a video display that may include a line of eyeglass selections, sometimes known as a visual search row 100 or glasses at a glance box wherein a plurality of eyeglass are presented on the basis of shape. The visual search row may include approximately eight or so glass frames of different shapes. A show filter box 200 may be presented above the visual search row. A lower display area 300 may present a selection of eye glasses that are a subset of or correspond to a selected frame from the visual search row. Each frame within the lower box may have an adjacent number indicating the number of subcategory selections. Selecting the show filter box reveals a plurality of additional filters that may include single or dual PD radio buttons, and pull down menus for price, RX type and hinge type.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

### Field of the Invention

The invention generally relates to computer screen displays and interfaces. More particularly, the invention relates to means and methods of presenting visual displays and search filters to sort and display eyeglasses on the basis of shape and other variables.

### BRIEF SUMMARY OF THE INVENTION

The present invention overcomes shortfalls in the related art by presenting an unobvious and unique combination and configuration of display boxes or user interface areas to aid in the quick and uncluttered selection of eyeglasses and eyeglass frames. A new user interface and display system provides a clear and uncluttered access to eyeglass products by an initial sorting based upon frame shape. A visual search row sometimes referred to as “glasses at a glance” presents a plurality of eyeglass products in a plurality of categories that may include, full rim plastic, full rim metal, full rim mixed materials, half rim (all materials) rimless, magnetic clip-ons and sports and googles.

Upon the selection of a product from the visual search row, a lower box presents a plurality of subcategory products with each subcategory product display comprising an integer indicating the number of further subcategory products available. The further subcategory products may be viewed by selecting a subcategory product. Further refinement of displayed products may be made by opening a filter box and selecting or entering product features within a plurality of filter interfaces. When the filter box is used, a more refined selection of products may be found within the lower box.

The disclosed embodiments overcome shortfalls in the art by sometimes keeping filters in an “open” position such that further selections may be made and so that a user does not get lost within the user interface or selection process. Advantages over the prior art are achieved by optionally placing the filter box superior to the visual search row and by placing the lower display area inferior to the visual search row. Advantages over the prior art are achieved by sometimes keeping the visual search row in a constant open or expanded position, keeping the show filter box displayed at all times, in either an expanded or contracted position.

Shortfalls in the prior art are also overcome by use of product shapes as a filter, category or subcategory of display or search. Often, a website or user interface is viewed by person who does not read in the presented language. Thus the use of shapes in refining product searches or in presenting categories is especially useful.

Furthermore, shortfalls in the prior art are overcome by the artful use of a model box displayed upon an upper flank of the visual row display. The model box may comprise a pre-stored picture of an eyeglass model or may comprise a user supplied picture. As different eyeglass products are selected, the model box will display such a selection.

### BRIEF DESCRIPTION OF THE DRAWINGS

FIG. 1 is a pseudo screen shot of a disclosed interface

FIG. 2 is a pseudo screen shot of a disclosed interface

FIG. 3 is a pseudo screen shot of a disclosed interface

FIG. 4 is a pseudo screen shot of a disclosed interface

FIG. 5 is a pseudo screen shot of a disclosed interface

### REFERENCE NUMERALS IN THE DRAWINGS

100 visual search row or glasses at a glance box

105 an unselected product from the visual search row

110 a selected product from the visual search row

111 a second selected product from the visual search row

112 a selected product marked with brackets

120 a selection summary display

200 show filter box or filter box in a contracted state

210 hide filter interface

220 filter interface in an expanded state

225 radio buttons for single PD or dual PD

230 drop down menu for PD

235 drop down menu for price range

240 drop down menu for type of RX or eyeglass prescription

250 drop down menu for metal type or material of frame

252 offered metal type or material of frame

254 question mark, triggering a sustained pop out box containing an explanation of an offered metal type 252

300 lower display area

305 adjustable boundary box section enclosing a selected frame from the visual search row and corresponding products shown in the lower display area

307 bottom section of an adjustable boundary box section, may comprise the lower display area or subsections thereof

310 number indicating the number of available further subcategory products

320 subcategories of products relating to a first selected model 410 of the visual row

400 model box

410 value of PD for model in the model box

420 eyeglasses upon the model, the eyeglasses matching a selected product 110

430 color selection within model box

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

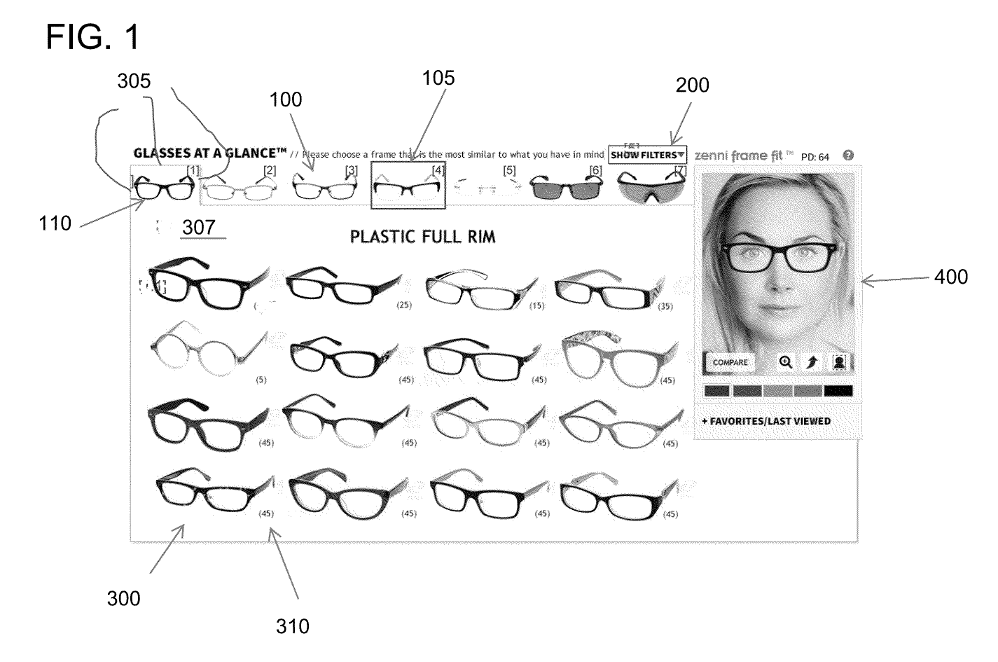

Referring to FIG. 1, a visual search row 100 or a “glasses at a glance box” is show below a show filter 200 interface, the show filter interface 200 in a contracted state. The visual search row 100 is shown with a plurality of products, such products may be categorized by having different shapes or other variables. A selected product 110 from the visual search row is shown to be encompassed by an adjustable boundary section 305. An adjustable boundary section 305 may have three sides, with each side adjacent to a selected product from the visual search row. The bottom section 307 of an adjustable boundary section may comprise the contents of the lower display area 300. An unselected product 105 from the visual search row is marked to show its exclusion from the adjustable boundary section 305 and from the lower display area. An optional model box 400 may float upon a side of the visual search row 100 and lower display area. The model box on the side overcomes shortfalls in the art by visually reminding a user of the attributes of a selected product.

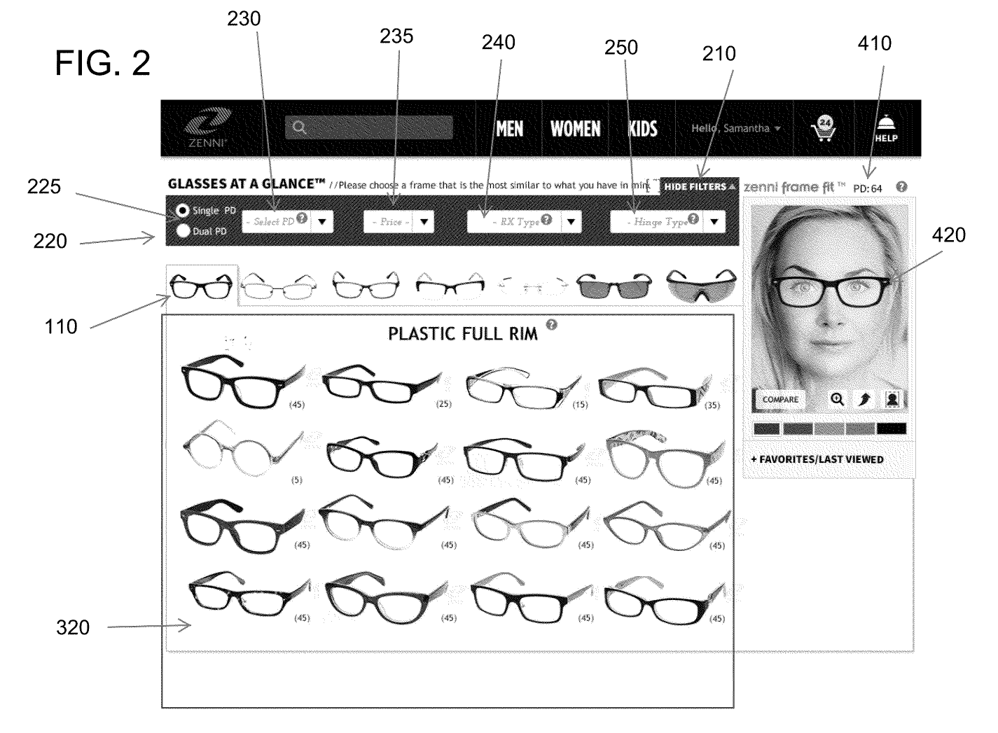

Referring to FIG. 2, a filter interface 220 is shown in an expanded state and retains a hide filter interface 210. The expanded user interface includes radio buttons 225 for single PD or dual PD; a drop down menu 230 for PD, a drop down menu 235 for price range, a drop down menu 250 for metal type or material of frame. The model box is populated with a value of PD 410. A selected frame 110 is shown with a subcategories of products 320 corresponding to or related to the selected product 110. A selected product may be a subset of products from the visual row.

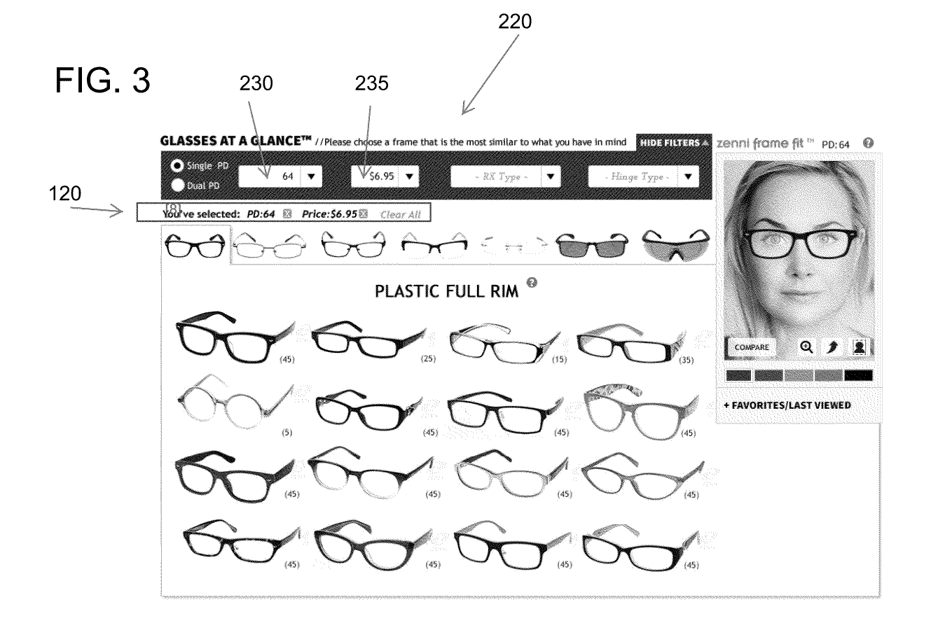

Referring to FIG. 3, a selection summary 120 may comprise a selected PD value, price and other values. The selection summary 120 may be placed between the visual row and expanded filter interface to provide a quick summary in an optimal location. Within the expanded filter interface 220, a user is shown to have populated the PD value 230 and price value 235, with such selections reflected within the selection summary 120.

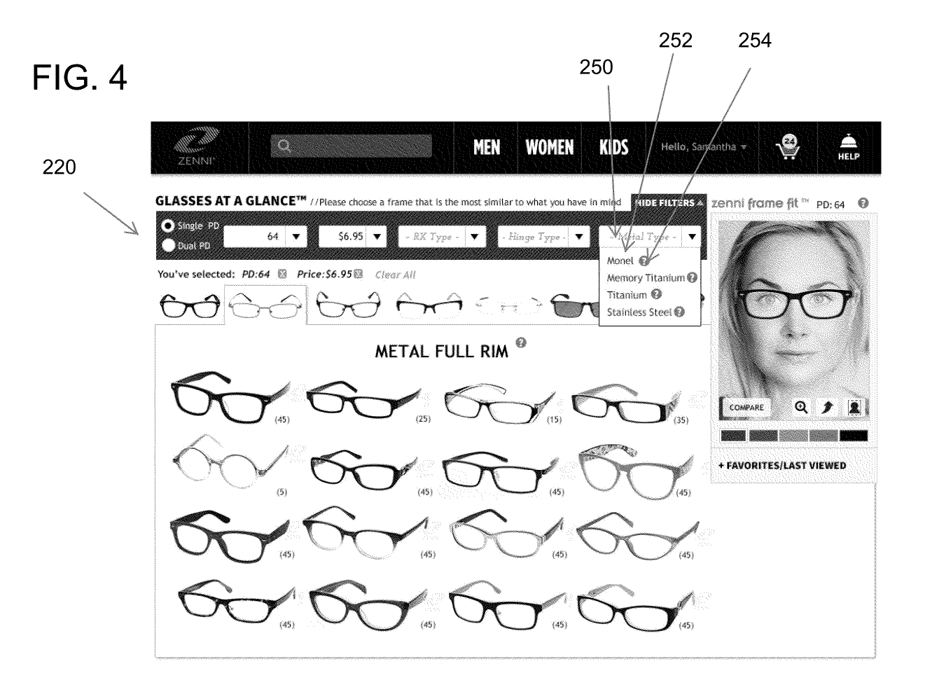

Referring to FIG. 4, a second selected product 111 is enclosed within a lower display area. The expanded filter interface 220 is shown and includes a drop down menu 250 for metal type or frame material in an expanded position showing an offered metal type 252 and an adjacent question mark 254. Selecting the question mark opens an answer box that describes an offered selection. The answer box may remain open for each of reference.

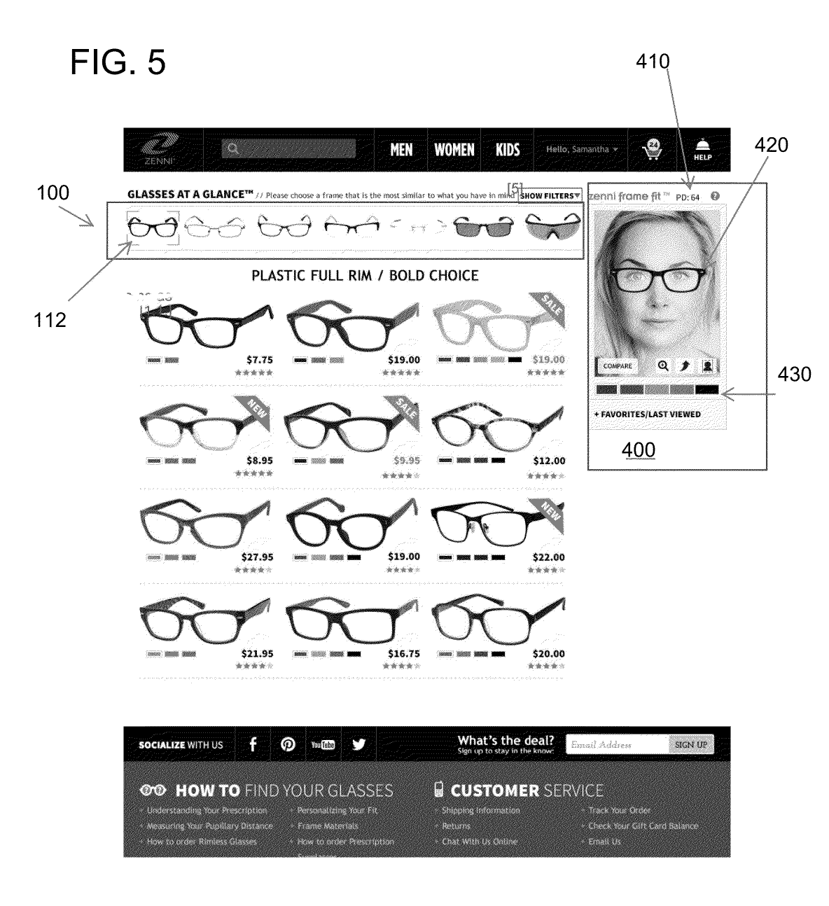

Referring to FIG. 5, a visual search row 100 is shown and a selected product is marked with brackets 112 and not part of the lower display area. This configuration is helpful to provide an alternative visual system. A model box 400 is shown with an optional color selection interface 430. The model within the model box is shown wearing a pair of selected glasses 420. A PD value 410 is displayed for the model.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

What is claimed is:

1. A computer implemented display system for the display and selection of eyeglasses, the display comprising:
a) a visual search row comprising a plurality of eyeglasses;
b) a show filter interface, located above the visual search row;
c) a lower display area, located below the visual search row, the lower display area comprising a plurality of eyeglasses comprising a subset of a user selected eyeglass of the visual search row,
d) each eyeglass of the lower display area comprising an integer corresponding a further subset of eyeglasses.

2. The display of claim 1 further comprising an adjustable boundary box section adjacent to a left, top and right side of a selected product from the visual search row and a lower section of the adjustable boundary box section defined by the lower display area.

3. The display of claim 1 wherein the plurality of eyeglasses of the lower display area are a subset of shapes corresponding to the shape of a selected eyeglass of the visual search row.

4. The display of claim 3 wherein the plurality of eyeglasses of the lower search area comprise a hyper link leading to the display of additional eyeglasses, the additional eyeglasses being related in shape to a selected eyeglass of the lower search area.

5. The display of claim 1 further including an expanded filter interface, the expanded filter interface comprising a plurality of interfaces including radio buttons for single PD or dual PD, a drop down menu for PD, a drop down menu for price range, a drop down menu for material of frame.

6. The display of claim 5 further including a hide filters interface.

7. The display of claim 6 further including a material type interface displaying a plurality of material types with questions marks next to each material type.

8. The display of claim 7 including hyperlinks upon each question mark and wherein selection of a question mark hyper link trigger a question box explaining a material.

9. The display of claim 5 further including a selection display summary located between the visual search row and the expanded filter interface.

10. The display of claim 9 wherein the selection display summary displays a user selected PD and price range.

11. The display of claim 1 further including a model box located to a side of the visual search row and the lower display area.

12. The display of claim 11 wherein a face within the model box is shown wearing eyeglasses selected by a user.

13. The display of claim 12 further including a PD value displayed within the model box.

14. The display of claim 12 further including a color selection interface within the model box.
